(19) United States
(12) Patent Application Publication
(10) Pub. No.: US 2016/0067723 A1
(43) Pub. Date: Mar. 10, 2016

(54) HYPOCYCLOID JET ROTOR AND FLOATING THRUST BEARING

(71) Applicant: TEMPRESS TECHNOLOGIES, INC., Renton, WA (US)

(72) Inventor: JACK J. KOLLE, Seattle, WA (US)

(73) Assignee: TEMPRESS TECHNOLOGIES, INC., Renton, WA (US)

(21) Appl. No.: 14/850,650

(22) Filed: Sep. 10, 2015

Related U.S. Application Data
(60) Provisional application No. 62/048,610, filed on Sep. 10, 2014.

(51) Int. Cl. B05B 3/06

(52) U.S. Cl. CPC B05B 3/06

(57) ABSTRACT

A compact reaction turbine jet rotor with much lower rotary speed, reduced manufacturing cost and greater tolerance to debris and wear is disclosed. Reduced rotary speed will allow faster drilling in a wider range of formations of economic interest. A simple brake mechanism will also reduce manufacturing cost.

### RELATED APPLICATIONS

The present application claims the benefit of U.S. Provisional Patent Application No. 62/048,610, filed on Sep. 10, 2014, which is herein incorporated by reference in its entirety.

### BACKGROUND

1. Field of the Invention

The present invention relates to a jet rotor with discharge jets that traverse a hypocycloid.

2. Description of the Related Art

Applicant previously obtained U.S. Pat. No. 7,198,456 for a Floating Head Reaction Turbine with Improved Jet Quality, which describes a compact rotary jetting tool. A similar prototype tool designed for zero-radius lateral drilling incorporates a rotor with discharge jets that are offset from the rotor axis to generate torque that spins the rotor and allows the jets to erode a circular hole. This tool operates at up to 20,000 psid and is capable of drilling a range of sandstone and other granular permeable formations. Because the tool is extremely short, it can turn inside of a shoe in casing to exit at an angle of 70 degrees from 4½″ casing.

Reaction turbine rotors with high pressure jets spin at extremely high runaway speed and require some sort of braking mechanism. The existing prototype tool relies on carbide weights that rub against the inside of the housing to slow the tool, but the operating speed is still in the range of 40,000 to 70,000 rpm. High rotary speed reduces the effectiveness of the jets and causes high wear. The existing design uses radial clearance seals that also act as the bushings that support the rotation of the tool. The tolerances on these seals are extremely small and any debris or misalignment can stop the rotor.

The Tempress Technologies, Inc. Jet Rotor® tool is also a reaction turbine rotor with pressure-balanced face seals. This tool is used to remove scale and debris from oil and gas production tubing. This rotor also requires brakes and various systems have been used including mechanical weights, eddy current brakes, and a hydrokinetic brake. This tool spins at around 3000 rpm, which is still too fast for many well service applications. The torque generated by the jets must be limited in order to prevent overspeed, but this leads to reliability issues when operating the tool on water with fine debris, which is common. The manufacturing cost of this tool is high, making it less competitive with lower cost tools on the market. There is a need for a slower speed jetting tool for both drilling and tubing cleaning applications.

A compact reaction turbine rotor with much lower rotary speed, reduced manufacturing cost, and greater tolerance to debris and wear is disclosed. Reduced rotary speed will improve the drilling performance of the prototype zero-radius lateral drilling tool described above, allowing faster drilling in a wider range of formations of economic interest. A simple brake mechanism would also reduce the cost of a rotary jetting tool.

### SUMMARY OF THE INVENTION

The present invention discloses a jet rotor with discharge jets that traverse a hypocycloid. The hypocycloid traversal of the jets is generated by the rotation of jet rotor within a journal bearing having a diameter sufficiently larger than the external diameter of the jet rotor. As drilling flows through the jet rotor, the rolling and sliding motion of the jet rotor within the journal bearing will squeeze the fluid. The motion acts as a breaking mechanism for the jet rotor, dissipating energy, causing the jet rotor to slow, and allowing the jet rotor to operate at rotary speeds that address the issues identified above.

### BRIEF DESCRIPTION OF THE DRAWINGS

FIG. 1 shows a hypocycloid curve representing the motion of a point on the rim of a rotor with radius 0.931 rolling in a circle with a diameter of 1.

FIG. 2A shows a transverse cross-sectional view of the embodiment of the jet rotor in FIG. 2B taken along section line AA.

FIG. 2B shows a longitudinal cross section view of an embodiment of the jet rotor.

FIG. 2C shows a view of the face of the embodiment of the jet rotor in FIG. 2B.

FIG. 3A shows a transverse cross-sectional view of the embodiment of the jet rotor in FIG. 3B taken along section line AA.

FIG. 3B shows a longitudinal cross section view of an embodiment of the jet rotor.

FIG. 3C shows a view of the face of the embodiment of the jet rotor in FIG. 3B.

FIG. 4A shows a longitudinal cross section view of an embodiment of the jet rotor.

FIG. 4B shows a transverse cross-sectional view of the embodiment of the jet rotor in FIG. 4A taken along section line BB above the plain bearing.

FIGS. 5A and 5B show, respectively, an embodiment of the jet rotor and an enlarged view of the hydrostatic floating bearing.

FIG. 6A shows a transverse cross-sectional view of the embodiment of the jet rotor in FIG. 6B taken along section line CC.

FIG. 6B shows a longitudinal cross section view of an embodiment of the jet rotor.

FIG. 6C shows a transverse cross-sectional view of the nozzle head 3C of FIG. 6B taken along section line EE.

### DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof, as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The invention incorporates a jet rotor with discharge jets that traverse a hypocycloid. In one embodiment, the invention also comprises a jet rotor with a pressure-balanced mechanical face seal at the inlet and a floating thrust bearing that supports the axial thrust on the rotor. Different embodiments are disclosed below.

In one embodiment, the journal bearing has a clearance that is larger than the critical clearance at which the rotor will whirl inside the journal. The onset of whirl is a well-known phenomenon in lightly loaded bearings and journal bearings are normally designed to avoid whirl.

The onset of whirl can be described by a non-dimensional number that represents the ratio of the contact force of a rotating eccentric mass to the hydrodynamic force that acts to prevent contact in a lubricated bearing:

$$Ω = \frac{3 ω m}{L μ} {( \frac{C}{R} )}^{3} ,$$

where:

ω is the angular speed;

m is mass of the rotating body supported by the bearing;

L is the length of the bearing;

μ is the fluid viscosity;

C is the radial clearance; and

R is the bearing radius.

(All units are consistent, such as SI (International System).)

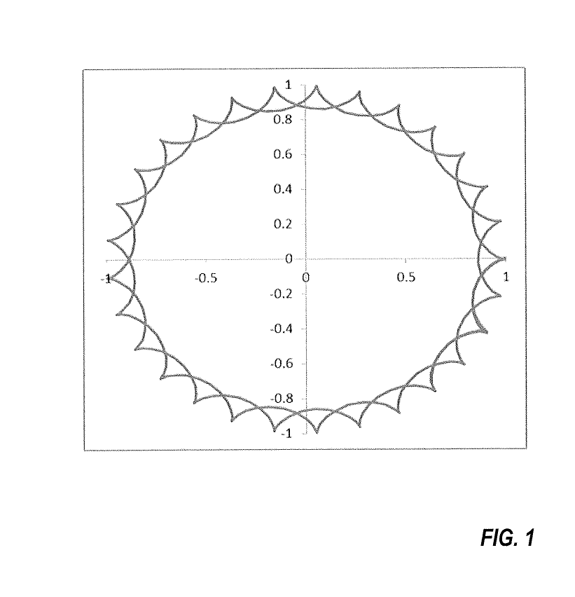

Whirl is likely when Ω>1. The whirl number is highly sensitive to the eccentricity of the bearing, C/R, so whirl is common unless the clearance is very small. Whirl is also more likely for a rotor with greater mass or lower fluid viscosity. The whirling motion results from contact of the rotor against the journal. Depending on the friction between the rotor and the journal, the rotor will slide, causing it to slow. If the friction is high enough the rotor will roll around the inside of the journal, causing the axis of the rotor and the paths of the jets to move on a hypocycloid curve, which is the motion of a point on a wheel that is riding on a larger circle. An example of a hypocycloid curve is shown in FIG. 1. The rolling and sliding motion of the rotor will squeeze the fluid, typically water, in a wedge ahead of the path, dissipating energy and also causing the rotor to slow.

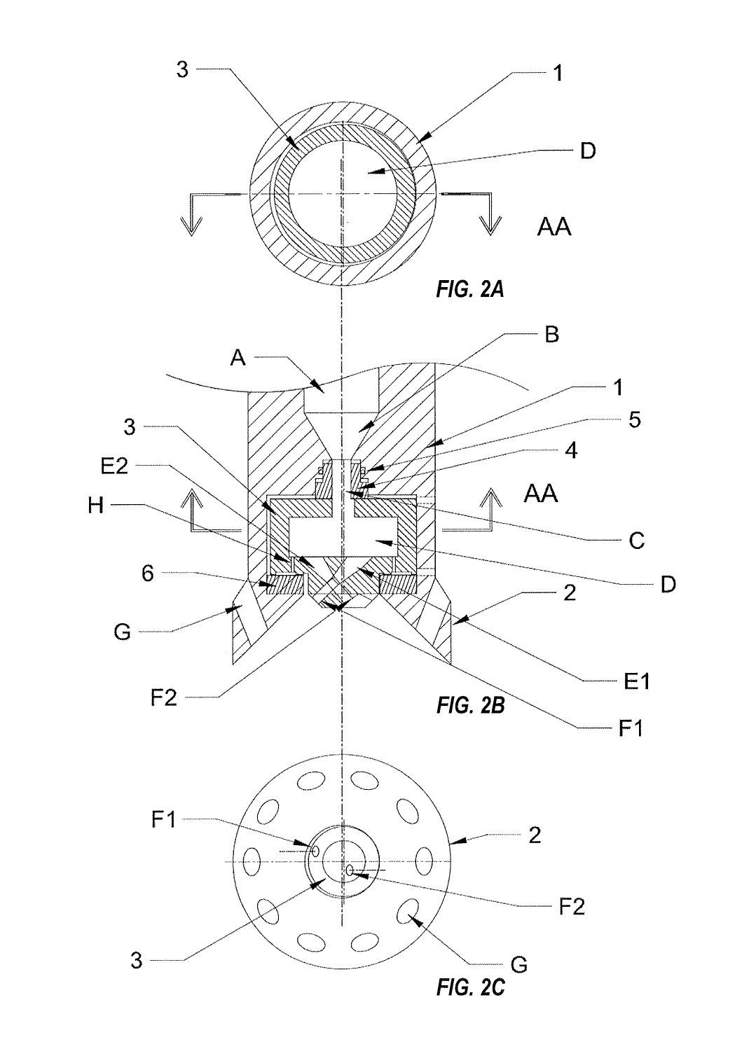

FIGS. 2A-2C illustrate an embodiment of the jet rotor of the present invention. Referring to FIG. 2B, the jet rotor consists of a housing 1 with an inlet passage A that is supplied with pressurized flow from a tube and pump (not shown). The flow passes though convergent passage B into the internal passage C of an upper face seal 4. Convergent passage B is provided to reduce the dynamic pressure acting upon upper face seal 4, thereby reducing the friction and drag between the face seal and the rotor. Upper face seal 4 is free to move axially and is engaged with housing 1 by O-ring seal 5. The flow passes into volume D of rotor 3. As shown in FIG. 2A by Section AA, the outer diameter of rotor 3 is smaller than the inner diameter of housing 1. This radial clearance allows the rotor to move radially until it comes into contact with the inner diameter of the housing and then to roll around the inside of the housing with the whirling motion described above. Flow from rotor volume D passes though one or more nozzle inlets (E1 and E2 in this embodiment) and nozzle outlets (F1 and F2). Referring to FIG. 2C, a face view shows that nozzle outlets F1 and F2 have axes that are offset from the center of the rotor 3 and generate reaction torque that causes the rotor to spin. At some speed the rotor will start to whirl and the jets will move along a hypocycloid curve similar to that shown in FIG. 1.

The jet rotor of the present invention may be deployed in a variety of different environments, including but not limited to a borehole for drilling rock or in a tube for removing debris. The housing 1 may have an enlarged section 2 with flow passages G to allow material removed by the whirling jets to move back up the borehole or tube being cleaned. The jets may align with the leading edge of this enlarged section to enable drilling of a gauge hole when weight is applied downwards on the housing.

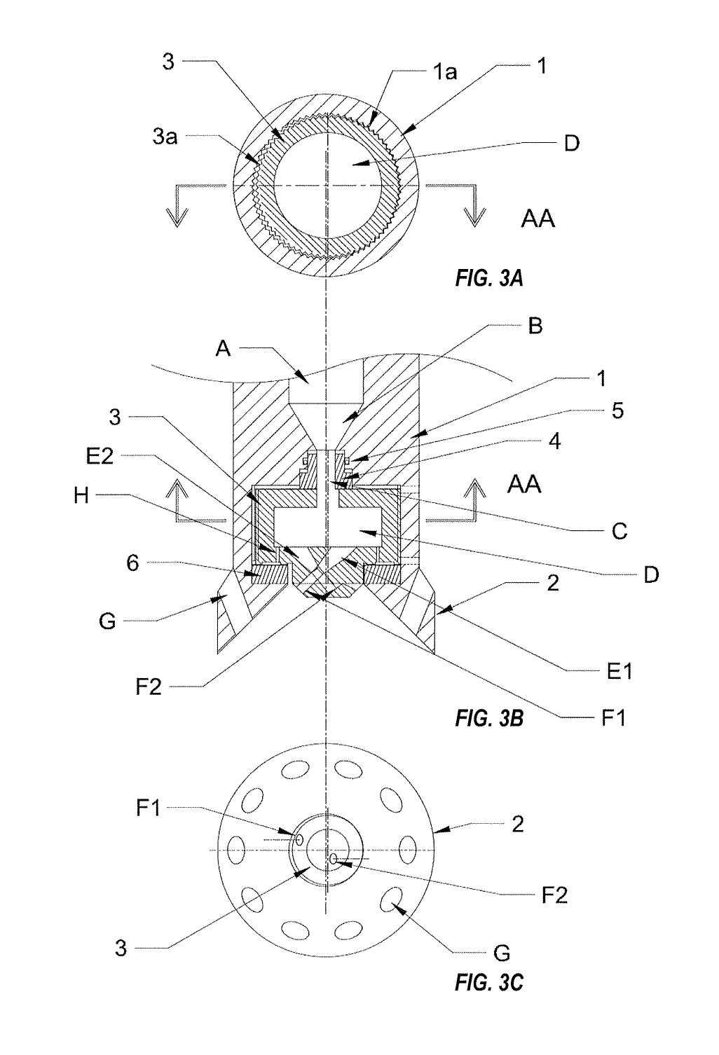

Another embodiment is shown in FIGS. 3A-3C. In FIG. 3A, the outside diameter of rotor 3 incorporates gear teeth 3a that engage with gear teeth 1a on the inner diameter of housing 1. The number of gear teeth 3a on the rotor are at least 1 smaller than the number of teeth 1a on the housing while the pitch is similar so that the teeth cause the rotor to roll smoothly around the inside of the housing. The height of the teeth may preferentially be chosen to be only slightly smaller than the eccentricity of the rotor relative to the housing so that the rotor cannot spin; however, this is not a requirement. Those skilled in the art of gear design will understand that the gear teeth are triangular in shape, as shown in FIG. 3A, in order to avoid tip fouling as the inner gear rolls on the outer gear. The tool will operate in a pressurized borehole so the volume between the rotor and housing is always fluid-filled. The rolling motion of the rotor will pump the fluid axially as the rotor rolls. This axial pumping will dissipate energy and cause the rotor to slow even more than the embodiment shown in FIGS. 2A-2C without gear teeth. In other aspects, the jet rotor embodiment of FIGS. 3A-3C may be similar to the embodiment shown in FIGS. 2A-2C.

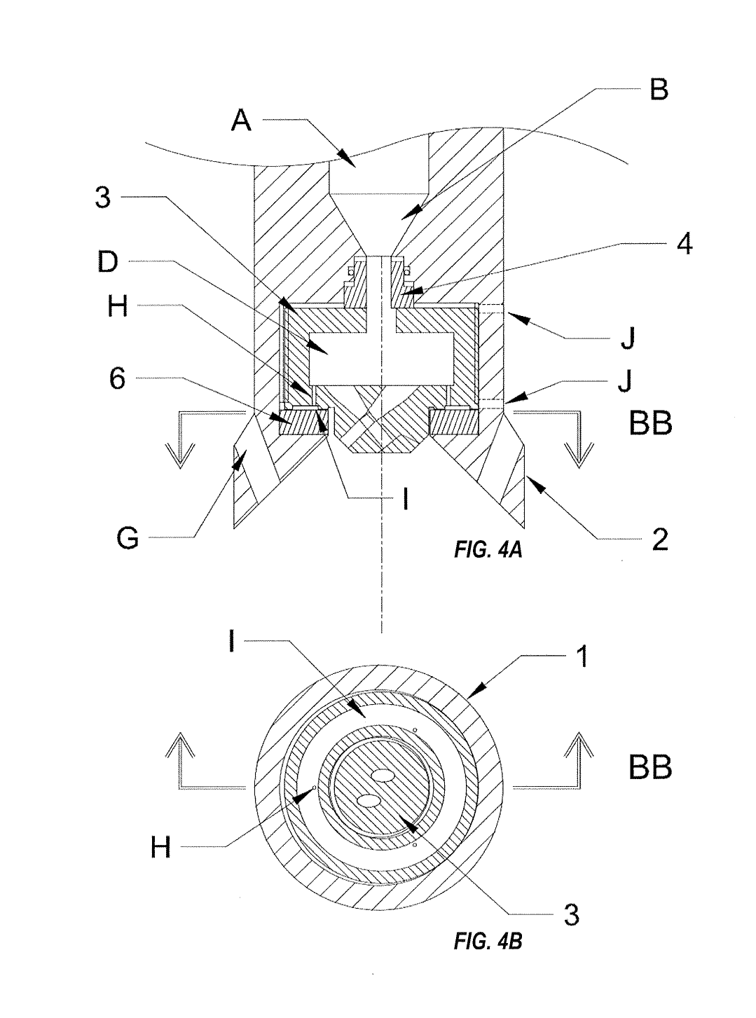

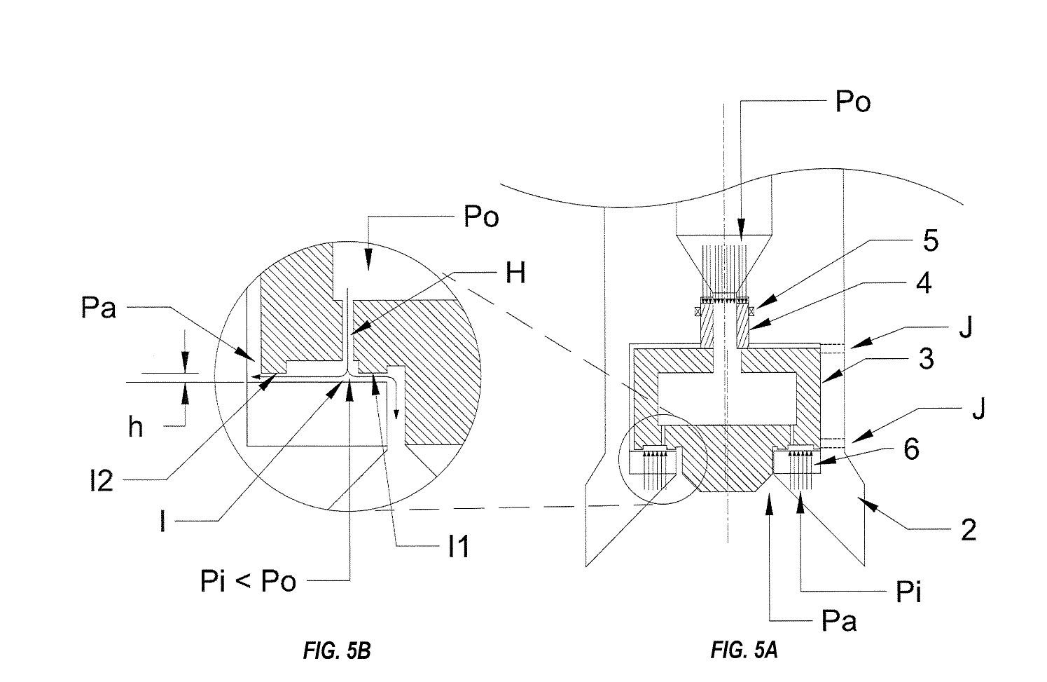

A more detailed view of the rotor face seals is provided in FIGS. 4A-4B. Referring to FIG. 4A, face seal 4 may include a step in diameter to reduce the contact stress and frictional resistance to rotation as is well known in the art of mechanical face seal design. The lower face of the rotor is designed to float above a plain bearing 6. Pressure in rotor volume D is transmitted through one or more small ports H into annular channel I shown by section BB in FIG. 4B. The rotor face is supported by plain bearing 6 so that when the rotor is seated against the bearing face the channel is sealed and pressure builds. The annular area of channel I is greater than the sealed area of face seal 4 so the pressure will urge the rotor to move up until it starts to leak. The leakage flow from both upper face seal 4 and the lower seal is vented though ports J so the pressure in the volume between the housing and the rotor is not pressurized. The circumference of the channel is large enough that a small opening will open a leak area that is much larger than the total flow area of ports H so the pressure in the channel will drop until a small gap is maintained and the rotor will float axially above the bearing. The combination of mechanical face seal 4, ports H, features in the rotor that form annular channel I and plain bearing 6 constitute a floating thrust bearing with low mechanical friction. The floating thrust bearing is shown in more detail in FIGS. 5A and 5B, described below. Note that the channel I may alternately be formed in the plain bearing 6.

In an embodiment, channel I may be excluded, and the cross sectional area of ports H is large enough to allow the bearing to float.

FIGS. 5A-5B show a pressure balanced rotor incorporating a pressure balanced face seal and a compensated hydrostatic bearing. FIG. 5A shows the pressure forces on the rotor 3 and the upper face seal 4. Note that the upper face seal in this figure is unstepped or it may be stepped as shown in FIGS. 2A, 3A, and 4A to reduce the mechanical contact stress on the rotor. Those skilled in the art of mechanical face seal design will understand that the pressure force transmitted to the rotor is the same in any case and is equal to the inlet pressure Po times the section area of the upper face seal 4 that is sealed with O-ring seal 5. In this illustration, the inlet pressure Po is shown to be uniform and equal the upstream pressure at inlet A. In this illustration the effect of the dynamic pressure reduction through convergent passage B is ignored. If the dynamic pressure loss due to the flow velocity at the exit of the convergent passage B is significant, the pressure acting on the annular upper face of the face seal will be reduced and this will also reduce the net down force on the rotor. This effect will be mitigated to some extent by pressure recovery as the flow velocity slows in the rotor. The downwards force on the upper face seal is transmitted to the rotor where it is supported by intermediate pressure Pi, which acts over the annular area of channel I formed by inner land I1 and outer land I2, shown in FIG. 5B. The inner radius of land I1 is open to ambient pressure Pa and the outer radius of land I2 is open to ambient pressure Pa through vent ports J in housing 2.

Referring to FIG. 5B, when the gap h is zero, there is no flow into annular channel I and the intermediate pressure Pi equals Po. The section area of the channel I is greater than the annular section area of the upper seal ring 5 so the rotor and upper seal ring will move upwards. The leakage flow through the gap increases rapidly as the gap height increases (roughly as the cube of the gap height). Ports H form a flow restriction so the leakage flow causes the intermediate pressure Pi to drop. When the gap is large enough the upward pressure force on rotor 3 balances the downward pressure force on upper seal ring 4. The area of the annular channel I, the radii of the inner and outer annular channel lands I1 and I2 and the diameter and number of ports H can be adjusted so that the bearing floats at a fixed small distance above plain bearing 6. The floating bearing may be called a hydrostatic thrust bearing or a compensated hydrostatic thrust bearing. It is preferably implemented as an orifice-compensated hydrostatic thrust bearing, but may also be implemented in other forms, such as a capillary-compensated hydrostatic thrust bearing, as known in the art of hydrostatic bearing systems.

In a preferred embodiment of the invention, the annular channel I is fed by two or three ports H to evenly support the rotor. The annulus is not strictly necessary but this provides the most straightforward means of controlling the gap so that the leakage flow is limited.

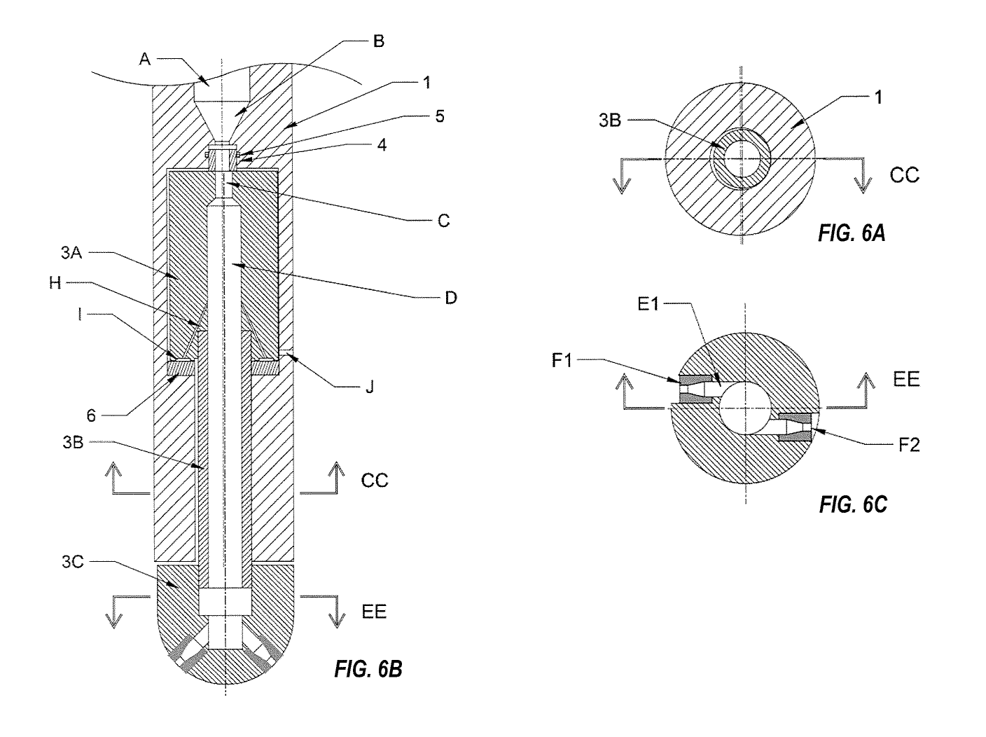

FIG. 6A-6C show an alternate embodiment of the invention. As seen in FIG. 6B, in this embodiment the rotor is a dumbell-shaped assembly with a nozzle head 3C that incorporates the reaction turbine jet nozzles F1 and F2, an upper portion 3A that incorporates an orifice-compensated hydrostatic thrust bearing and a whirling shaft 3B that connects 3A and 3C and includes a flow passage D. An elongated flow passage as shown will improve pressure recovery from the flow accelerated though convergent passage B. This pressure recovery will increase the pressure differential though the jet nozzle in nozzle head 3C and improve the overall efficiency of the rotor. The illustration shows a short divergent taper connecting flow passages C and D. Those skilled in the art will understand that a long divergent taper could be incorporated here to act as a diffuser to further improve pressure recovery. FIG. 6C shows a cross-section view of the nozzle head 3C along section line EE. The nozzle head 3C may incorporate additional nozzles as well. The rotor assembly is designed to have its center of gravity near the middle of whirl shaft 3B. The outer diameter of 3B is designed to whirl inside of a reduced section of the housing as shown by the cross sectional view along section line CC in FIG. 6A. As noted earlier by the whirl equations, the tendency to whirl increases with the mass of the rotor and is inverse to the cube of the radius of the whirling shaft. This configuration allows for the incorporation of a relatively large nozzle head for cleaning applications while ensuring that the rotation remains balanced. Alternatively, the interface between the outer diameter of 3B and the inner diameter of the reduced section of the housing may incorporate gear teeth that engage with each other in a manner similar to the embodiment of FIGS. 3A-3B.

The embodiments presented here are exemplary and are not meant to be limiting. The hypocycloid jet approach shown may be incorporated into a compact jet drill in order to improve the erosion pattern and slow the jets for more effective drilling. This approach could also be incorporated into a jet rotor for well cleaning where slow rotation and a hypocycloid jet pattern will provide better coverage. Either configuration could incorporate a larger jetting head for better jet quality and performance. The jet rotor of the present invention could also be incorporated in other tools or environments.

The floating thrust bearing disclosed here could also be used in conventional jet rotors that rotate about a fixed axis.

Other configurations may be possible, and the configurations shown herein are not meant to be limiting. Although the concepts disclosed herein have been described in connection with the preferred form of practicing them and modifications thereto, those of ordinary skill in the art will understand that many other modifications can be made thereto. Accordingly, it is not intended that the scope of these concepts in any way be limited by the above description.

1. A rotary jetting tool comprising:
a housing with an inlet and an outlet, the housing comprising an inner cylindrical surface; and
a rotor arranged within the inner cylindrical surface of the housing, the rotor comprising an outer cylindrical surface, the diameter of the outer cylindrical surface of the rotor being less than the diameter of the inner cylindrical surface of the housing, the rotor comprising jets that move along a plane hypocycloid path.

2. The rotary jetting tool of claim 1, wherein the hypocycloid path of the jets is the result of whirl of the rotor inside of the housing, wherein sufficient clearance exists between the inner cylindrical surface of the housing and the outer cylindrical surface of the rotor to allow the rotor to roll around the internal cylindrical surface, wherein any point on the rotor describes a plane hypocycloid curve.

3. The rotary jetting tool of claim 2, wherein the rotor is in fluid communication with the inlet of the housing through a fluid passage in a face seal bushing that is sealingly engaged with the inlet to the housing, wherein the face seal bushing includes a planar distal surface that slides on a planar proximal surface of the rotor, wherein the face seal bushing is free to move axially within the housing.

4. The rotary jetting tool of claim 3, wherein the rotor comprises an internal passage in fluid communication with the jets, wherein the jets are offset from the axis of the rotor cylinder so that fluid discharge though the jets results in a rotational moment on the rotor.

5. The rotary jetting tool of claim 1, wherein the outer cylindrical surface of the rotor comprises teeth, wherein the inner cylindrical surface of the housing comprises teeth, wherein the teeth on the outer cylindrical surface of the rotor engage with the teeth on the inner cylindrical surface of the housing.

6. The rotary jetting tool of claim 5, wherein the teeth on the outer cylindrical surface of the rotor are a pitch that is substantially similar a pitch of the teeth on the inner cylindrical surface of the housing.

7. The rotary jetting tool of claim 5, wherein the number of teeth on the inner cylindrical surface of the housing is at least one more than the number of teeth on the outer cylindrical surface of the rotor.

8. The rotary jetting tool of claim 1, further comprising a pressure-balanced mechanical face seal at the inlet of the housing.

9. The rotary jetting tool of claim 1, wherein the rotor is arranged to move axially within the housing.

10. The rotary jetting tool of claim 9, further comprising a hydrostatic thrust bearing at the outlet of the housing, wherein the rotor further comprises ports with flow restrictions that allow fluid communication between the internal passage of the rotor to a surface of the thrust bearing, wherein the pressure transmitted though the ports moves the rotor off of the surface to the point where leakage between the rotor and the plain thrust bearing causes the rotor to float above the surface.

11. The rotary jetting tool of claim 3, further comprising a pressure-balanced mechanical face seal at the inlet of the housing.

12. The rotary jetting tool of claim 3, wherein the rotor is arranged to move axially within the housing.

13. The rotary jetting tool of claim 12, further comprising a hydrostatic thrust bearing at the outlet of the housing, wherein the rotor further comprises ports with flow restrictions that allow fluid communication between the internal passage of the rotor to a surface of the thrust bearing, wherein the pressure transmitted though the ports moves the rotor off of the surface to the point where leakage between the rotor and the plain thrust bearing causes the rotor to float above the surface.

14. The rotary jetting tool of claim 4, further comprising a pressure-balanced mechanical face seal at the inlet of the housing.

15. The rotary jetting tool of claim 4, wherein the rotor is arranged to move axially within the housing.

16. The rotary jetting tool of claim 15, further comprising a hydrostatic thrust bearing at the outlet of the housing, wherein the rotor further comprises ports with flow restrictions that allow fluid communication between the internal passage of the rotor to a surface of the thrust bearing, wherein the pressure transmitted though the ports moves the rotor off of the surface to the point where leakage between the rotor and the plain thrust bearing causes the rotor to float above the surface.

17. The rotary jetting tool of claim 5, further comprising a pressure-balanced mechanical face seal at the inlet of the housing.

18. The rotary jetting tool of claim 5, wherein the rotor is arranged to move axially within the housing.

19. The rotary jetting tool of claim 18, further comprising a hydrostatic thrust bearing at the outlet of the housing, wherein the rotor further comprises ports with flow restrictions that allow fluid communication between the internal passage of the rotor to a surface of the thrust bearing, wherein the pressure transmitted though the ports moves the rotor off of the surface to the point where leakage between the rotor and the plain thrust bearing causes the rotor to float above the surface.

20. The rotary jetting tool of claim 1 where the inlet converges.
